(19) United States
(12) Patent Application Publication
(10) Pub. No.: US 2002/0003765 A1
(43) Pub. Date: Jan. 10, 2002

(54) Signal processing device and signal processing method

(76) Inventors: Masaharu Matsumoto, Katano City (JP); Takashi Katayama, Hirakata City (JP); Masahiro Sueyoshi, Hirakata City (JP); Kousuke Nishio, Moriguti City (JP); Takeshi Fujita, Takatuki City (JP); Akihisa Kawamura, Hirakata City (JP); Kazutaka Abe, Toyonaka City (JP)

Correspondence Address: SMITH PATENT OFFICE, 1901 PENNSYLVANIA AVENUE N W, SUITE 200, WASHINGTON, DC, 20006

(21) Appl. No.: 09/899,994

(22) Filed: Jul. 9, 2001

(30) Foreign Application Priority Data
Jul. 10, 2000 (JP) 2000-208139

(51) Int. Cl. G11B 7/005

(52) U.S. Cl. 369/59.21

(57) ABSTRACT

A decoding circuit inputs a data stream D3 which has been multiplexed at different sampling frequencies, and separates it into two audio data D1 and D2 at different sampling frequencies, which it supplies to buffers. The output of the buffer is inputted to an up-sampling circuit, which, along with performing up-sampling at a frequency which corresponds to a processing unit of data of which the time delay amount is predetermined, also suppresses aliasing distortion. On the other hand, the output of the buffer is inputted to a delay buffer, which delays it by a time delay amount the same as that due to the up-sampling circuit. By doing this, the reproducing phases of the two streams of audio signals are coincided.

### BACKGROUND OF THE INVENTION

1. Field of the Invention

The present invention relates to a signal processing device and method which perform signal processing for reproducing multi-channel audio data been recorded upon an optical disk or the like, without generating a delay time difference between a plurality of streams of audio data digitized at different sampling frequencies.

2. Discussion of the Related Art

Optical disks upon which audio data is recorded in multi-channel format have pervaded the market. A DVD audio disk or a DVD video disk carries a greater amount of information than that of an audio CD by far, thereby it can provide a clear and natural sound. Furthermore the so-called DVD player, which reproduces this type of optical disk, is virtually ubiquitous.

In the case of a DVD, the information capacity is greater than 4 GB, and upon it there is recorded an application such as a movie. The information read out rate of a DVD player is about 10 Mbps. Although it is desirable to employ a high sampling rate for the audio signal in order to achieve high sound quality, if the sound is in multi-channel format, the reading out rate can exceed the above value. In this kind of situation, there is a demand both for further enhancement of the sound quality and also for increase of the number of channels.

### SUMMARY OF THE INVENTION

The present invention provides a signal processing device and method which fulfill this requirement. Since the signal processing device and the signal processing method of the present invention perform up-sampling of the multi-channel audio signals which are read out from the recording medium. The device and method compensate the time delay of the audio data according to this up-sampling. Therefore it becomes possible easily to adjust the phase when reproducing the two audio signals by adapting the processing characteristics of the up-sampling filter to the processing unit for data, and also by adapting the processing unit for decoding of the data to the processing characteristics of the up-sampling filter. And, moreover, the present invention provides a disk player which implements this signal processing method.

In order to do this, the signal processing device of the present invention includes a decoder, a filter and a delay unit. The decoder decodes a data stream which includes first and second audio data sampled at different sampling frequencies fs1 and fs2, with fs1<fs2. And the decoder inputs encoded data and separates them as the first and second audio data. Among the first and second audio data which are outputted from the decoder, the filter performs re-sampling of the first audio data at the same sampling frequency fs2 as that of the second audio data, and suppresses, aliasing distortion due to re-sampling. And, among the first and second audio data which are outputted from the decoder, a delay unit delays the second audio data by just the amount of processing period due to the filter, and outputs it as a second audio data.

### BRIEF DESCRIPTION OF THE DRAWINGS

FIG. 1 is a block diagram showing the structure of an encoding device;

FIG. 2 is a block diagram showing the structure of a basic signal processing device;

FIG. 3 is an explanatory view showing sampling data in a basic signal processing device;

FIG. 4 is an explanatory view showing encoded data in an encoding device;

FIG. 5 is a block diagram showing the structure of a signal processing device according to a first preferred embodiment of the present invention;

FIG. 6 is a block diagram showing the structure of an up-sampling circuit included in this signal processing device;

FIG. 7A is a first theoretical view showing the operation of a delay buffer which is used in this signal processing device;

FIG. 7B is a second theoretical view showing the operation of a delay buffer which is used in this signal processing device; and

FIG. 8 is a block diagram showing the structure of a signal processing device according to a second preferred embodiment of the present invention.

### DETAILED DESCRIPTION OF THE PREFERRED EMBODIMENTS

The inventors of the present application have pursued the study and development of audio reproducing devices for many years. And the inventors are currently performing investigation and development, within the limitations of the specifications for the values of recording capacity and output bit rate of a video signal and an audio signal which are recorded upon an optical disk, to make it more possible both to enhance the sound quality of the audio signal and also to increase the number of channels thereof.

As described previously, when outputting an audio signal like a DVD audio signal which has high sound quality, the number of output channels is typically six. For example, the forward left and right channels are signals sampled at about 96 kHz or 88.2 kHz. While, due to restrictions of recording capacity on the optical disk, signals of the forward C channel, the backward left channel and right channel, and deep bass channel are sampled at about 48 kHz or 44.1 kHz. This combination of sampling frequencies is regulated by various standards, of which there are several.

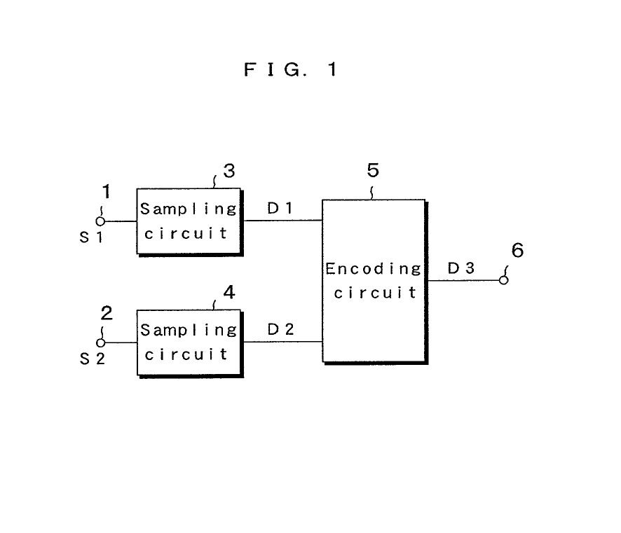

FIG. 1 is a block diagram showing the structure of an encoding device, which samples two audio signal streams at different sampling frequencies for recording them upon an optical disk described above. This encoding device converts the two audio signals into a first audio data and a second audio data, and encodes these two signals of audio data as a single data stream. Analog audio signals S1 and S2 are inputted to this encoding device via terminals 1 and 2. A sampling circuit 3 inputs the audio signal S1, performs sampling at a sampling frequency fs1 of 48 kHz or 44.1 kHz, and converts it to the first audio data. And a sampling circuit 4 inputs the audio signal S2 of the second stream, performs sampling at a sampling frequency fs2(=2×fs1), i.e. 96 kHz or 88.2 kHz, and converts it to the second audio data.

The audio data D1 which has been sampled by the sampling circuit 3 and the audio data D2 which has been sampled by the sampling circuit 4 are inputted to an encoding circuit 5. The encoding circuit 5 encodes these several audio data streams and outputs them as a single data stream D3. Furthermore the encoding circuit 5 appends, as headers to each predetermined number of data items, parameters which give the specification of this data. The data series of predetermined length to which these headers are appended are termed “blocks” or “frames”. The data stream D3 formed in this manner is outputted to an external device via an output terminal 6, and is recorded upon an optical disk via an optical disk recording device, or is supplied to a transmission device or the like.

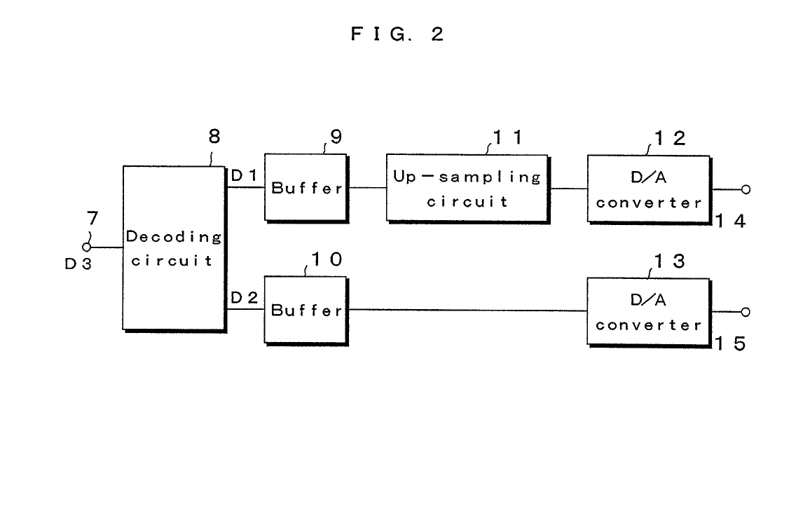

A prototype signal processing device has been manufactured which separates a data stream of this type which has been read out from an optical disk into its several constituent data streams. A block diagram of this signal processing device is shown in FIG. 2. The output data stream from the above described recording and reproducing device or transmission device is inputted to a terminal 7 of this signal processing device, and a decoding circuit 8 divides the encoded data stream D3 one block at a time into the original audio data D1 and D2 of two different types. And the decoding circuit 8 outputs the first audio data D1 to a buffer 9, and outputs the second audio data D2 to a buffer 10. And an up-sampling circuit 11 inputs the first audio data D1 at a sampling frequency of 48 kHz or 44.1 kHz, and performs up-sampling thereof at approximately twice as high as the frequency, so as to convert it to an audio data at a sampling frequency of 96 kHz or 88.2 kHz. A D/A converter 12 converts the up-sampled audio data into an analog audio signal. And a D/A converter 13 converts the output data from the buffer 10 into an analog audio signal. These analog audio signals are output to the outside via respective output terminals 14 and 15.

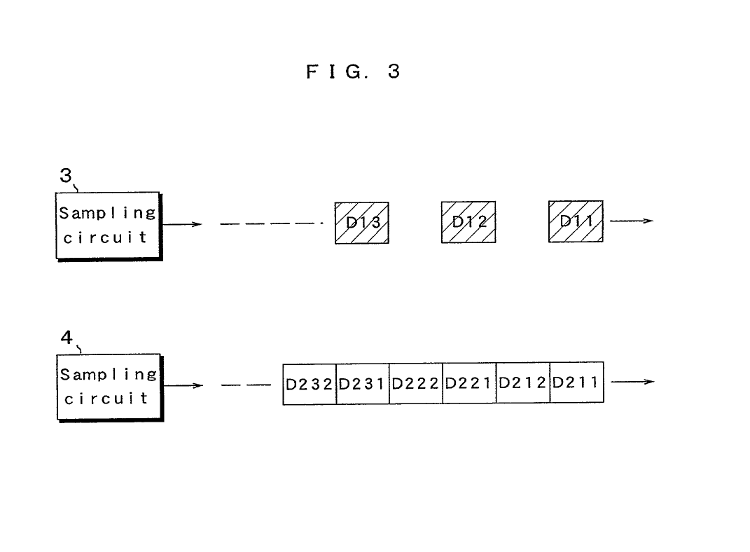

FIG. 3 shows the audio data which have been sampled by the sampling circuits 3 and 4. D11, D12, D13 . . . are data elements of the audio data which has been sampled by the sampling circuit 3. And D211, D212, D221, D222, D231, D232 . . . are data elements of the audio data which has been sampled by the sampling circuit 4. In this manner, the first sampling frequency for the first audio data is two times higher than that of the second sampling frequency. In other words, the data which has been sampled by the sampling circuit 3 corresponds to about half the quantity of data which has been sampled by the sampling circuit 4.

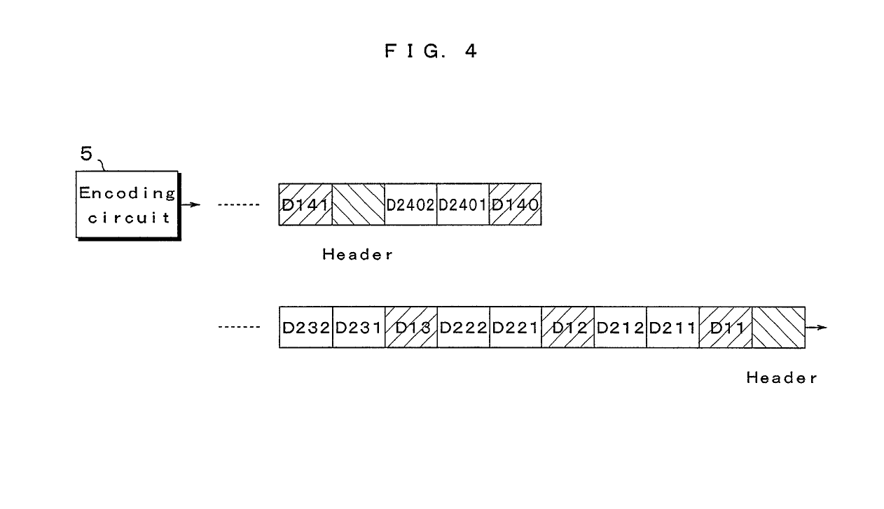

FIG. 4 shows the data stream D3 which has been encoded by the encoding circuit 5. The encoding is arranged so that the reproducing times in analog form of the data elements which have been sampled should be the same. For example, the arrangement may have two data elements of D2j (j=11, 12, 21, 22, . . . 401, 402) following after one data element of D1i (i=1, 2, . . . 40), so that 40 samples of data from the sampling circuit 3 and 80 samples of data from the sampling circuit 4 constitute one block. And the encoding circuit 5 appends to each block header data (“Header”), which records the sampling frequency for its data and the like.

However with the above described signal processing device the phase when outputting analog audio signals to the outside undesirably mutually differs, since a time delay in the data is generated due to the up-sampling processing. In other words, the mutual timing of the two signals deviates. For example, suppose that D2j is the audio signal for the forward left channel and right channel, while D1i is the audio signal which includes the backward left channel and right channel. In this case, if the same audio signal is outputted by the sound source on these two signal, a phase cancel is generated at the location of a listener, and an audio signal is generated whose characteristic differs from that of the original sound source, which is undesirable. The same phenomenon occurs for the forward central channel C and the forward left channel and right channel.

In order to solve these problems, the signal processing device and signal processing method according to the present invention have been developed. Various embodiments thereof will be explained in the following disclosure.

Embodiment 1

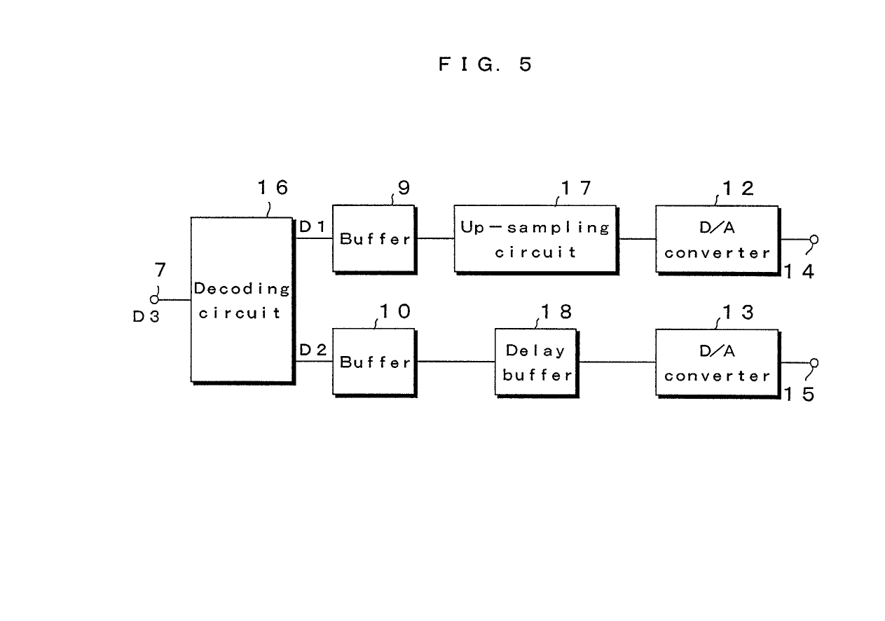

FIG. 5 is a block diagram showing the structure of an embodiment 1 of the signal processing device of the present invention. To structural elements in this embodiment 1 signal processing device which are identical to structural elements of the signal processing devices described above the same reference symbols are appended.

Data sampled from a first audio signal and a second audio signal at respective sampling frequencies fs1 and fs2, where fs1<fs2, constitute a first audio data and a second audio data. If the data stream was created by encoding first and second audio data as a single data stream, the signal processing device of the present embodiment is one which returns to the respective first and second audio data without generating any time difference between the two streams of the data.

This signal processing device comprises a decoding circuit 16, a first buffer 9, a second buffer 10, an up-sampling circuit 17, a delay buffer 18, a first D/A converter 12, and a second D/A converter 13.

The decoding circuit 16 is a circuit which inputs via a terminal 7 a data stream D3 in which the first and second audio data have been encoded and combined by an encoding circuit like the encoding circuit 5 of FIG. 1, and which, by referring to the header data, separates said data stream D3 into a first audio data D1 and a second audio data D2 and decodes them, thus returning to respective audio data at sampling frequencies fs1 and fs2. The buffer 9 is a device for temporarily storing the first audio data D1. And the buffer 10 is a device for temporarily storing the second audio data D2.

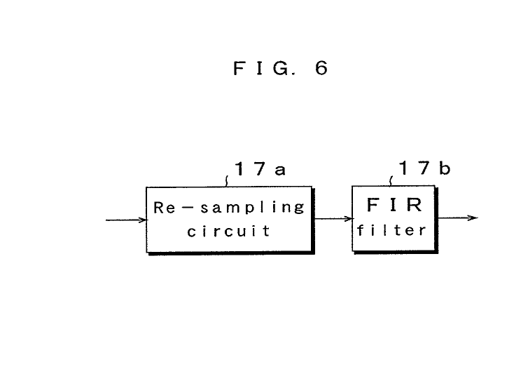

The up-sampling circuit 17 is a filter which, among the plurality of streams of audio data which are outputted from the decoding circuit 16, performs re-sampling of the first stream of audio data D1 at the high sampling frequency fs2 which is the same as that of the second audio data D2, and which outputs a first stream of audio data in which aliasing distortion generated by this re-sampling has been suppressed. This up-sampling circuit 17, as shown in FIG. 6, comprises a re-sampling circuit 17a and an FIR filter 17b. The re-sampling circuit 17a is so constituted that, when for example it inputs the values D11, D12, D13 . . . in the first audio data D1, it inserts a value “zero” in between each data element and the next, so as to double the number of output data items. And the FIR filter 17b is a low pass filter which suppresses the aliasing distortion generated by this re-sampling.

The delay buffer 18 is so constituted that, among the plurality of streams of audio data which are outputted from the decoding circuit 16, it introduces a delay period which is just the processing period of the up-sampling circuit 17 into the second stream of audio data D2 whose sampling frequency is fs2, then outputting it as the second audio data D2. And the D/A converter 12 is a circuit which converts the output data from the up-sampling circuit 17 into analog form, then outputting it via the output terminal 14 to the outside. Moreover, the D/A converter 13 is a circuit which converts the output data from the delay buffer 18 into analog form, then outputting it via the output terminal 15 to the outside.

The decoding operation of this signal processing device structured as described above will now be explained. A data stream D3 which has been encoded by an encoding circuit like the encoding circuit 5 shown in FIG. 1 is inputted via the terminal 7 to the decoding circuit 16. The decoding circuit 16 extracts the header data from the headers of this data stream D3, and separates said data stream D3 into a first audio data D1 which corresponds to the sampling frequency fs1 of 48 kHz or 44.1 kHz, and a second audio data D2 which corresponds to the sampling frequency of fs2(=2×fs1) of 96 kHz or 88.2 kHz. The first audio data D1 is inputted into the buffer 9, while the second audio data D2 is inputted into the buffer 10.

In this manner the following procedures are executed for each block in the data stream D3: (1) the headers are removed; (2) it is separated into the two data D1 and D2; and (3) these audio data D1 and D2 are outputted to the buffers. In other words, these procedures are performed for each group of 40 samples of the first audio data D1 and for each group of 80 samples of the second audio data D2. The first and second audio data D1 and D2 which have been outputted every one block from this decoding circuit 16 are respectively inputted to the buffers 9 and 10.

Next the output data from the buffer 9 is inputted to the up-sampling circuit 17. The up-sampling circuit 17 performs up-sampling upon this inputted data at approximately twice the sampling frequency, in consideration of the number of data elements (in this case 80) in one block of the second audio data D2. If for example the FIR filter 17b is used in the up-sampling circuit 17, then its delay amount will be equal to (N+1)/2 in terms of the tap number N of the FIR filter 17b. Accordingly, if the number of data elements in the second audio data D2 is supposed to be 80, then the characteristics of the FIR filter 17b are set so that its tap number N should be equal to 159, in order for this delay amount to become adequate for 80 samples.

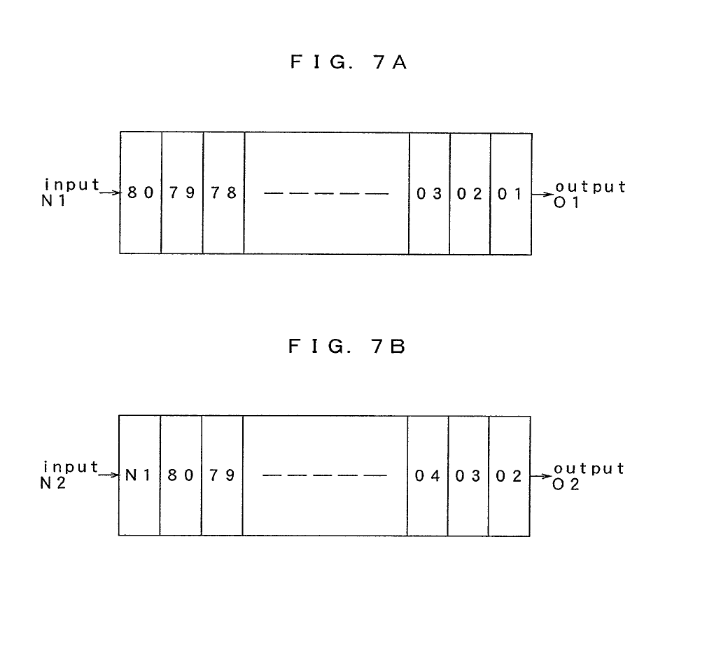

On the other hand, the output data elements from the buffer 10 are inputted to the delay buffer 18. This delay buffer 18 generates the delay period of one block by storing the number of data elements in one block (=80 data elements). The delay buffer 18 has a structure as shown in FIGS. 7A and 7B. FIG. 7A shows the input-output state at a certain time point, while FIG. 7B shows the input-output state at the next clock signal. When one data N1 is inputted, the delay buffer 18 outputs the data element 01 among previously stored data elements 01 to 80. Actually, the input data N1 is inputted at a clock rate which is synchronized with the sampling frequency. The delay amount of the signal is easily controlled by, in this manner, making the tap number of the FIR filter in the up-sampling circuit 17 equal to the number of data elements in one block of audio data which is inputted.

The output of the up-sampling circuit 17 is converted into an analog signal by the D/A converter 12, and is outputted via the output terminal 14 to the outside. Moreover, the output of the delay buffer 18 is converted into an analog signal by the D/A converter 13, and is outputted via the output terminal 15 to the outside. By this type of processing, the two streams of audio signals are outputted with their phases coincided.

When this type of signal processing method is applied to multi-channel DVD audio, no phase difference or time difference is generated in the output sound, even when, for example, the sampling frequency fs2 for the forward left channel and right channel signals is 96 kHz or 88.2 kHz while the sampling frequency fs1 for the surround-sound signals including the backward signals is 48 kHz or 44.1 kHz. Due to this it is possible to obtain the same sound field effect as the originally recorded audio or sound.

Embodiment 2

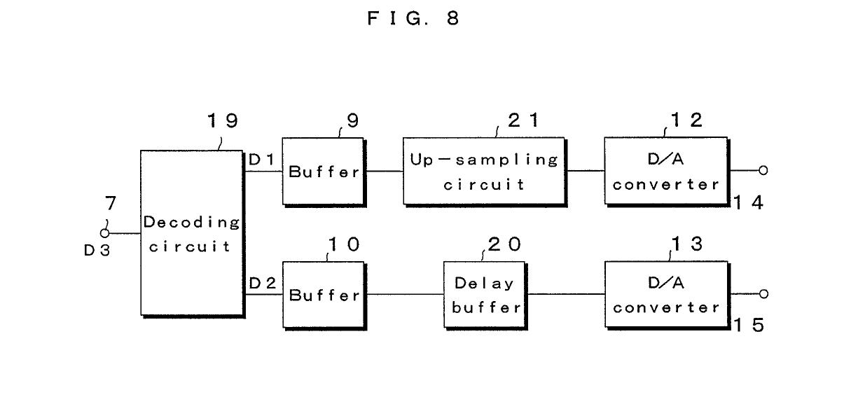

FIG. 8 is a block diagram showing the structure of a signal processing device according to a second preferred embodiment of the present invention. It should be noted that, in FIG. 8, to structural elements in this second preferred embodiment signal processing device which are identical to structural elements of the embodiment 1 signal processing device described above the same reference symbols are appended; and their description will be curtailed. This signal processing device comprises a decoding circuit 19, a first buffer 9, a second buffer 10, a delay buffer 20, an up-sampling circuit 21, a first D/A converter 12, and a second D/A converter 13. Furthermore, the up-sampling circuit 21 comprises a re-sampling circuit and an FIR filter, just as in the embodiment 1 described above.

The reproducing operation of this signal processing device according to the embodiment 2 will now be explained. A data stream D3 which has been encoded by an encoding circuit like the encoding circuit 5 shown in FIG. 1 is inputted via the terminal 7 to the decoding circuit 19. The decoding circuit 19 extracts the header data from this data stream D3, and separates the data stream D3 into a first audio data D1 which corresponds to the sampling frequency fs1 of 48 kHz or 44.1 kHz, and a second audio data D2 which corresponds to the sampling frequency of fs2 of 96 kHz or 88.2 kHz. The first audio data D1 is inputted into the buffer 9, while the second audio data D2 is inputted into the buffer 10.

In this manner the decoding circuit 19 executes the following procedures for each number of data elements which corresponds to the delay period introduced by the processing by the up-sampling circuit 21: (1) the headers are removed; (2) the data stream D3 is separated into the two data D1 and D2; and (3) these audio data D1 and D2 are outputted to the buffers.

For example, if the time delay by the up-sampling circuit 21 corresponds to the time for analog reproducing of 60 data elements in the data stream D3, then the decoding circuit 19 separates the headers every 60 data elements in the data stream D3, separates said data stream D3 into the first audio data D1 and the second audio data D2, and outputs these audio data to the respective buffers. By doing this, the first audio data D1 of 20 data elements from the decoding circuit 19 is inputted into the buffer 9, while the second audio data D2 of 40 data elements is inputted into the buffer 10.

Next the output data from the buffer 9 is inputted to the up-sampling circuit 21, which is a filter. Further, the output data from the buffer 10 is inputted to the delay buffer 20 which stores 40 data elements of the second audio data D2, so that a time delay of 40 data elements is generated. The operation of this delay buffer 20 is basically the same as that of the delay buffer 18.

The output of the up-sampling circuit 21 is converted into an analog signal by the D/A converter 12, and is outputted via the output terminal 14 to the outside. Moreover, the output of the delay buffer 20 is converted into an analog signal by the D/A converter 13, and is outputted via the output terminal 15 to the outside. By this type of processing, the two streams of audio signals are outputted with their phases coincided.

When this type of signal processing method is applied to multi-channel DVD audio, no phase difference or time difference is generated in the output sound when the optical disk reproducing device has played this DVD, even if the sampling frequencies for the forward left channel and right channel signals which constitute the second audio signal and for the surround signals which constitute the first audio signal are different. Furthermore, in the decoding circuit 19, decoding processing becomes possible in a processing time corresponding to that of the up-sampling circuit 21.

It should be understood that it is possible to include the above described type of signal processing device function or signal processing method in an optical disk reproducing device. Furthermore, the signal processing device function or signal processing method may be used in the form of a software program or of an application program on a personal computer. In such a case, the function of the decoding circuit 16 or 19 is implemented by a decoding step in which the encoded data stream is inputted, and the audio data streams are respectively recovered at their original sampling frequencies. Furthermore, the function of the up-sampling circuit 17 performs as a filtering step which includes a re-sampling step and an aliasing distortion suppression step. In the re-sampling step, among the first and second audio data streams outputted from the decoding step, re-sampling is performed upon the audio data stream which has the low sampling frequency of fs1 at the sampling frequency fs2. In the aliasing distortion suppression step, aliasing distortion is suppressed. And the function of the delay buffer is implemented by a delay processing step in which, among the first and second audio data streams outputted from the decoding step, the audio data stream which has the high sampling frequency is delayed by the delay period equal to the processing period due to the filtering step, and the resulting audio data is outputted.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A signal processing device which decodes a data stream which includes a first audio data and a second audio data sampled at different respective sampling frequencies of fs1 and fs2, where fs1<fs2, comprising:
a decoder which is inputted said data stream and separates said data stream into said first audio data and said second audio data;
a filter which, among said first and second audio data outputted from said decoder, performs re-sampling upon said first audio data at the same sampling frequency fs2 as that of said second audio data, and suppresses aliasing distortion due to said re-sampling; and
a delay unit which, among said first and second audio data outputted from said decoder, delays said second audio data by a delay period equal to a processing period due to said filter.

2. A signal processing device according to claim 1, wherein said decoder separates said data stream, processing unit thereof corresponding to said processing period in said filter, into said first and second audio data having original sampling frequencies, respectively.

3. A signal processing device according to claim 1, wherein signal processing delay time in said filter corresponds to a predetermined processing unit of inputted audio data.

4. A signal processing device according to claim 1, wherein said filter comprises:
a re-sampling circuit which, among the first and second audio data which are outputted from said decoder, performs re-sampling upon said first audio data having said sampling frequency of fs1 at said sampling frequency fs2 as that of said second audio data; and
an FIR filter which suppresses aliasing distortion in said first of audio data.

5. A signal processing device according to claim 1, wherein said second stream of audio data includes at least audio data for a forward right channel and audio data for a forward left channel.

6. A signal processing device according to claim 2, wherein said second stream of audio data includes at least audio data for a forward right channel and audio data for a forward left channel.

7. A signal processing device according to claim 3, wherein said second stream of audio data includes at least audio data for a forward right channel and audio data for a forward left channel.

8. A signal processing device according to claim 1, wherein said sampling frequency fs1 is one of 48 kHz and 44.1 kHz, and said sampling frequency fs2 is twice as high as said sampling frequency fs1.

9. A signal processing device according to claim 2, wherein said sampling frequency fs1 is one of 48 kHz and 44.1 kHz, and said sampling frequency fs2 is twice as high as said sampling frequency fs1.

10. A signal processing device according to claim 3, wherein said sampling frequency fs1 is one of 48 kHz and 44.1 kHz, and said sampling frequency fs2 is twice as high as said sampling frequency fs1.

11. A signal processing device according to claim 1, wherein:
said second stream of audio data includes at least audio data for a forward right channel and audio data for a forward left channel;
said sampling frequency fs1 is one of 48 kHz and 44.1 kHz; and
said sampling frequency fs2 is twice as high as said sampling frequency fs1.

12. A signal processing method which decodes a data stream which includes a first audio data and a second audio data sampled at different respective sampling frequencies of fs1 and fs2, where fs1<fs2, comprising:
a decoding step of inputting said data stream and separating said data stream into said first audio data and said second audio data;
a filtering step of, among said first and second audio data outputted from said decoding step, performing re-sampling upon said first audio data at the same sampling frequency fs2 as that of said second audio data, and suppressing aliasing distortion due to said re-sampling; and
a delay processing step of, among said first and second audio data outputted from said decoder, delaying said second audio data by a delay period equal to a processing period due to said filtering step.

13. A signal processing method according to claim 12, wherein said decoding step separates said data stream, processing unit thereof corresponding to said processing period in said filter step, into said first and second audio data having original sampling frequencies, respectively.

14. A signal processing method according to claim 12, wherein said processing period in said filtering step corresponds to a predetermined processing unit of inputted audio data.

15. A signal processing method according to claim 12, wherein said filtering step comprises:
a re-sampling step of, among the first and second audio data outputted from said decoding step, performing re-sampling upon the first audio data having said sampling frequency of fs1 at the said sampling frequency fs2 as that of the second audio data; and
a filtering step of suppressing aliasing distortion in said first audio data.

16. A signal processing method according to claim 12, wherein said second stream of audio data includes at least audio data for a forward right channel and audio data for a forward left channel.

17. A signal processing method according to claim 12, wherein said sampling frequency fs1 is one of 48 kHz and 44.1 kHz, and said sampling frequency fs2 is twice said sampling frequency fs1.

18. A signal processing method according to claim 12, wherein:
said second audio data includes at least audio data for a forward right channel and audio data for a forward left channel;
said sampling frequency fs1 is one of 48 kHz and 44.1 kHz; and
said sampling frequency fs2 is twice as high as said sampling frequency fs1.

19. An optical disk reproducing device which reproduces multi-channel audio signals using a signal processing device according to claim 8, when reproducing an optical disk upon which said first and second audio data, which have been sampled at respective different sampling frequencies fs1 and fs2 with fs1<fs2, have been recorded as a single stream of audio data.
